(19) United States
(12) Patent Application Publication
(10) Pub. No.: US 2015/0337875 A1
(43) Pub. Date: Nov. 26, 2015

(54) Hydraulic Actuator Gland

(71) Applicant: Swanson Industries, Morgantown, WV (US)

(72) Inventor: Douglas R. Helfrich, New Philadelphia, OH (US)

(21) Appl. No.: 14/719,275

(22) Filed: May 21, 2015

Related U.S. Application Data
(60) Provisional application No. 62/001,345, filed on May 21, 2014.

(51) Int. Cl. F15B 15/14

(52) U.S. Cl. CPC F15B 15/1447; F15B 15/1438

(57) ABSTRACT

Various embodiments of a hydraulic actuator gland and a hydraulic actuator are provided. In one embodiment, a hydraulic actuator gland comprises: an outer bearing carrier; an intermediate bearing carrier; and an inner bearing carrier; wherein the outer bearing carrier is oriented axially closer to a distal end of the gland; wherein the inner bearing carrier is oriented axially closer to a proximal end of the gland; and wherein at least a portion of the intermediate bearing carrier is oriented axially between the outer bearing carrier and the inner bearing carrier.

### CROSS-REFERENCE TO RELATED APPLICATIONS

This application claims priority from U.S. Provisional Patent Application No. 62/001,345, filed on May 21, 2014, which is incorporated by reference herein in its entirety.

### BACKGROUND

Offshore oil platforms and oil drillships stationed in the ocean or other large bodies of water often include a riser connected to the platform or drillship itself at one end and the ocean floor at the other end. Where an offshore oil platform or oil drillship is designed to float on the ocean surface, the platform or drillship moves with the ocean surface due to the force of waves, tides, currents, etc. Such movement may include lateral displacement, vertical displacement, pitch, roll, or combinations thereof. Movement of the offshore oil platform or oil drillship can cause the platform or drillship to move relative to the riser. In order to avoid damage to the riser, the riser may need to be maintained in a specific tension, position, angle, etc. relative to both the rig and the ocean floor. Accordingly, hydraulic actuators are typically employed to control the movement of the riser relative to the platform or drillship.

Hydraulic actuators used to control the movement of a riser relative to a platform or drillship are often quite large and include a stroke of several meters. When the hydraulic actuator's piston rod is extended, lateral/bending forces exerted upon the piston rod end may cause a significant moment upon the piston rod. This moment may in turn cause significant forces between the piston rod and the cylinder barrel, particularly in the gland region of the cylinder barrel. The gland region of the cylinder barrel is the distal-most portion of the cylinder barrel, and is near, or includes, the opening in the cylinder from which the piston rod may extend. These forces may cause abrasion, scoring, gouging, and the like of the piston rod, the gland, the piston, the cylinder barrel, and/or the seals of the hydraulic actuator. The abrasion, scoring, gouging and the like may result in leaking of hydraulic oil from the cylinder barrel, passage of fluid past the piston, and/or loss of the ability to build proper pressure in the hydraulic actuator.

Loss of hydraulic oil through the gland and out of the hydraulic actuator may create potential environmental hazards where standard hydraulic oil is used. Alternatively, environmentally-safe hydraulic oil often used in hydraulic actuators stationed in the ocean, lakes, and other bodies of water is very expensive (approximately $4.50/L at the time of filing this application), with each hydraulic actuator operating with between about 2,650 and about 3,785 liters of hydraulic oil. Where leakage of hydraulic oil from the hydraulic actuator or past the piston is severe enough, the hydraulic actuator may need to be removed from service and returned to port for repair. In such an event, the offshore oil platform or oil drillship itself may need to be returned to port for removal and/or repair of the hydraulic actuator. The offshore oil platform or oil drillship may only travel between the drill site and the port at between about 18 kmh and about 74 kmh, with downtime costs ranging between about $500,000 and about $800,000 per day out of service at the time of filing this application. Accordingly, damage to the hydraulic actuators used in the offshore oil platform or oil drillship can be extremely costly.

What is needed is an improved hydraulic actuator gland to prevent abrasion, scoring, gouging, and the like of the piston rod, gland, piston, cylinder barrel, and/or seals of the hydraulic actuator during application of lateral/bending forces on the piston rod.

### SUMMARY

In one embodiment, a hydraulic actuator is provided, the hydraulic actuator comprising: a proximal end; a distal end; a cylinder barrel; a piston rod oriented at least partially within the cylinder barrel; and a gland oriented near the distal end, the gland including an outer bearing carrier, an intermediate bearing carrier, and an inner bearing carrier, wherein the outer bearing carrier is oriented axially closer to the distal end; wherein the inner bearing carrier is oriented axially closer to the proximal end; and wherein at least a portion of the intermediate bearing carrier is oriented axially between the outer bearing carrier and the inner bearing carrier.

In one embodiment, a hydraulic actuator gland is provided, the hydraulic actuator gland comprising: an outer bearing carrier; an intermediate bearing carrier; and an inner bearing carrier; wherein the outer bearing carrier is oriented axially closer to a distal end of the gland; wherein the inner bearing carrier is oriented axially closer to a proximal end of the gland; and wherein at least a portion of the intermediate bearing carrier is oriented axially between the outer bearing carrier and the inner bearing carrier.

In another embodiment, a hydraulic actuator gland is provided, the hydraulic actuator gland comprising: an outer bearing carrier; an intermediate bearing carrier; an inner bearing carrier; at least one bearing carrier wear bearing oriented between the outer bearing carrier and the intermediate bearing carrier; at least one bearing holder; and at least one bearing carrier wear bearing oriented between the inner bearing carrier and the at least one bearing holder; wherein the outer bearing carrier is oriented axially closer to a distal end of the gland; wherein the inner bearing carrier is oriented axially closer to a proximal end of the gland; and wherein at least a portion of the intermediate bearing carrier is oriented axially between the outer bearing carrier and the inner bearing carrier.

### BRIEF DESCRIPTION OF THE DRAWINGS

The accompanying figures, which are incorporated in and constitute a part of the specification, illustrate various example configurations, and are used merely to illustrate various example embodiments. In the figures, like elements bear like reference numerals.

FIG. 1 illustrates an offshore oil platform having a riser and hydraulic actuators.

FIG. 2 illustrates a hydraulic actuator.

FIG. 3 illustrates a partial view of a hydraulic actuator having a gland.

FIG. 4A illustrates a partial, sectional view of a hydraulic actuator 400 having a gland 414.

FIG. 4B illustrates a partial, sectional view of gland 414.

FIG. 4C illustrates a partial, sectional view of gland 414.

FIG. 5 illustrates a partial, sectional view of a prior art gland.

### DETAILED DESCRIPTION

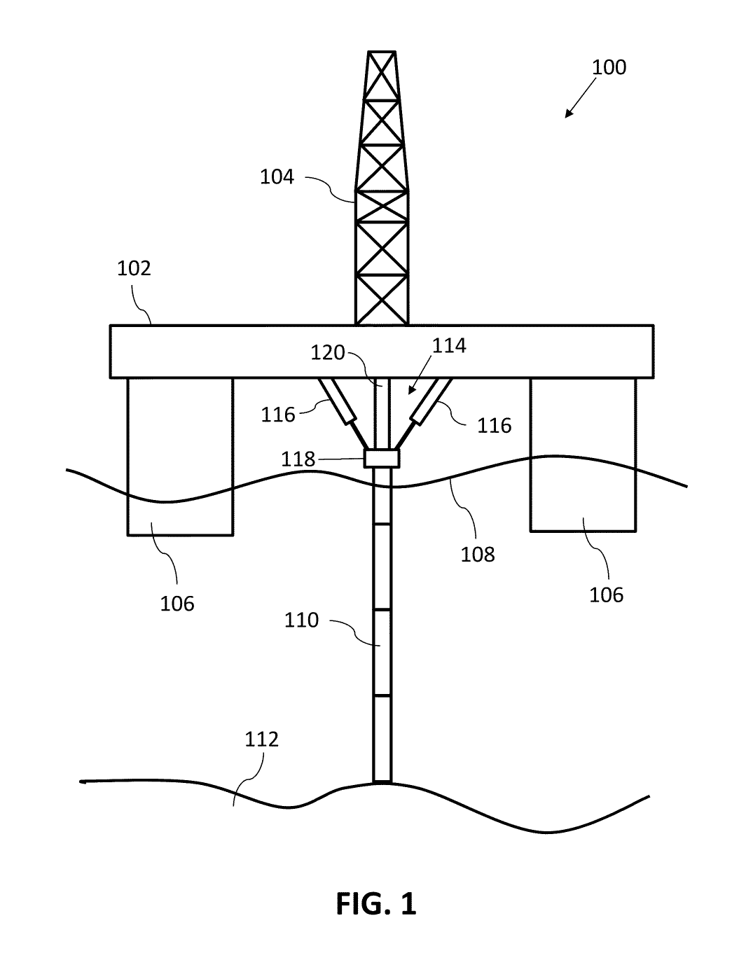

FIG. 1 illustrates an offshore oil platform 100 including a hull 102, a derrick 104, and at least one pontoon 106. Platform 100 may be configured to float upon a water surface 108 of a body of water, including for example an ocean, lake, sea, river, etc. A riser 110 may extend between platform 100 and a floor 112. Floor 112 may be, for example, an ocean floor, lake floor, sea floor, or river bed.

Riser 110 may be connected to platform 100 in a moon pool portion 114 of hull 102. At least one hydraulic actuator 116 may extend between platform 100 and a tensioning ring 118 connected to riser 110. Riser 110 may include an upper riser 120 configured to telescope, bend, or otherwise flex.

As illustrated, platform 100 is an offshore oil platform. In another embodiment, platform 100 is part of a drillship. In another embodiment, platform 100 is any vessel having physical communication with floor 112, including for example a research vessel, search vessel, a cable ship, or the like. At least one pontoon 106 may have a positive buoyancy, and may be configured to maintain platform 100 in contact with, and selectively positioned relative to, surface 108.

Riser 110 may be a drilling riser. Riser 110 may contain at least one of a casing, electrical conduit, and fluid lines for communication with a blowout preventer. Riser 110 may include a single large-diameter pipe, a set of concentric pipes, or various pipes clustered together/within one another. Riser 110 may be connected to floor 112. Riser 110 may extend below floor 112.

At least one hydraulic actuator 116 may be connected at one end to platform 100, and at an opposite end to riser 110. In one embodiment, at least one hydraulic actuator 116 may connect directly to riser 110. In another embodiment, at least one hydraulic actuator 116 may connected to tensioning ring 118 and tensioning ring 118 may connect directly to riser 110. Upper riser 120 may extend above tensioning ring 118 to platform 110. Upper riser 120 may be flexible, telescopic, or both to allow for movement of riser 110 and/or tensioning ring 118 relative to platform 110.

At least one hydraulic actuator 116 may be configured to maintain riser 110 at a specific tension. At least one hydraulic actuator 116 may be configured to maintain riser 110 within a specific range of tensions. At least one hydraulic actuator 116 may be configured to maintain riser 110 in a specific position. At least one hydraulic actuator 116 may be configured to maintain riser 110 in a specific position relative to floor 112. At least one hydraulic actuator 116 may be configured to maintain riser 110 at a specific angle relative to at least one of platform 100 and floor 112. At least one hydraulic actuator 116 may be configured to prevent riser 110 from bending, buckling, or otherwise deflecting more than is acceptable.

Six hydraulic actuators 116 may be used in conjunction to maintain riser 110 in desired tension and/or position on platform 100. In another embodiment, four hydraulic actuators 116 may be used in conjunction to maintain riser 110 in desired tension and/or position on platform 100. In another embodiment, less than four hydraulic actuators 116 may be used in conjunction to maintain riser 110 in desired tension and/or position on platform 100. In another embodiment, three hydraulic actuators 116 may be used in conjunction to maintain riser 110 in desired tension and/or position on platform 100. In another embodiment, greater than six hydraulic actuators 116 may be used in conjunction to maintain riser 110 in desired tension and/or position on platform 100. In another embodiment, between four and six hydraulic actuators 116 may be used in conjunction to maintain riser 110 in desired tension and/or position on platform 100.

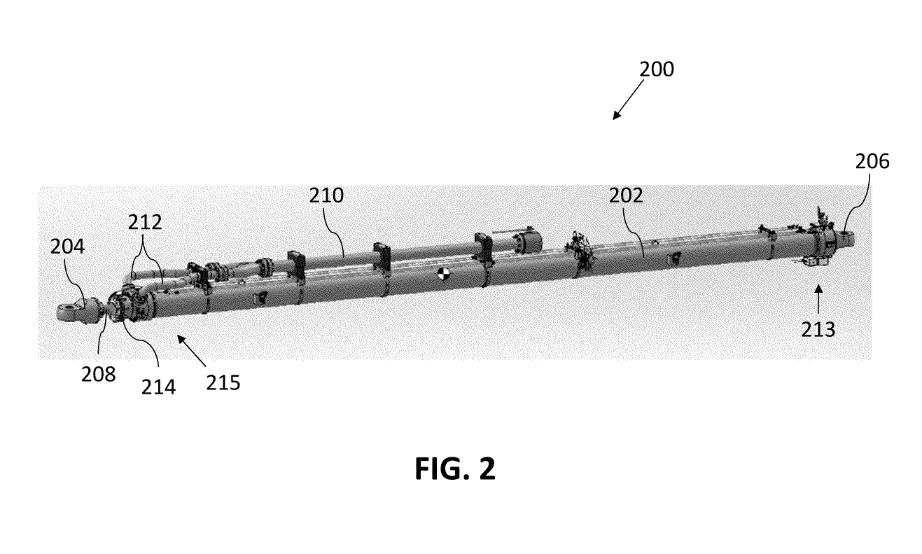

FIG. 2 illustrates a hydraulic actuator 200. Hydraulic actuator 200 may include a proximal end and a distal end. Hydraulic actuator 200 may include a cylinder barrel 202, a distal rod end 204, and a proximal rod end 206. Hydraulic actuator 200 may include a piston rod 208, which connects at its distal end to distal rod end 204, and which connects at its proximal end to a piston (not shown) contained within cylinder barrel 202. Hydraulic actuator 200 may include an accumulator 210 in fluid communication with at least one inlet/outlet flow pipe 212. Cylinder barrel 202 may include a gland 214 at its cylinder distal end 215.

Hydraulic actuator 200 may be configured for use on an offshore oil platform, a drillship, or the like. Hydraulic actuator 200 may be configured for use on a vessel configured to float on a water surface. Hydraulic actuator 200 may be any of a variety of known hydraulic actuators used for a variety of purposes, including for example use on machinery or use on equipment, whether on a water surface or land. While specific examples of hydraulic actuator 200 included herein regard use of hydraulic actuator 200 in conjunction with tensioning of a riser, it is contemplated that hydraulic actuator 200 could be used in any capacity in which hydraulic actuators are typically used.

Cylinder barrel 202 may comprise a hollow tube or pipe. Cylinder barrel 202 may include a bore of up to about 117 cm. Cylinder barrel 202 may include a bore of greater than about 117 cm. Cylinder barrel 202 may include a bore of less than about 117 cm. Cylinder barrel 202 may include any of a variety of diameters, simply dependent upon the application of hydraulic actuator 200.

Cylinder barrel 202 may be closed at cylinder proximal end 213. Cylinder barrel 202 may be selectively closed at cylinder proximal end 213 via a cover, which may be secured to cylinder barrel 202. Cylinder barrel 202 may contain a piston (not shown) having an outer diameter about equal to the bore of cylinder barrel 202. Cylinder barrel 202 may contain a piston (not shown) having an outer diameter less than the bore of cylinder barrel 202. Cylinder barrel 202 may include two chambers divided by the piston (not shown): (1) the bottom chamber, oriented between the piston and cylinder proximal end 213; and (2) the piston rod chamber, oriented between the piston and gland 214.

In one embodiment, hydraulic actuator 200 includes a hydraulic oil in the piston rod chamber. The hydraulic oil in the piston rod chamber may have a peak operating pressure of up to about 20,700 kPa. The hydraulic oil in the piston rod chamber may have a peak operating pressure of less than about 20,700 kPa. The hydraulic oil in the piston rod chamber may have a peak operating pressure of greater than about 20,700 kPa. Upon extension of piston rod 208, at least a portion of the hydraulic oil in the piston rod chamber may move from the piston rod chamber, through at least one inlet/outlet flow pipe 212, and into accumulator 210. Upon retraction of piston rod 208, at least a portion of the hydraulic oil in accumulator 210 may move from accumulator 210, through at least one inlet/outlet flow pipe 212, and into the piston rod chamber.

Hydraulic actuator 200 may include a gas in the bottom chamber. The gas in the bottom chamber may be maintained at a pressure of about 800 kPa. The gas in the bottom chamber may be maintained at a pressure less than about 800 kPa. The gas in the bottom chamber may be maintained at a pressure greater than about 800 kPa.

Hydraulic actuator 200 may include a hydraulic oil in the bottom chamber. Hydraulic actuator 200 may include a second accumulator (not shown) in fluid communication with the bottom chamber.

Hydraulic actuator 200 may be a double acting hydraulic actuator. Hydraulic actuator 200 may be a single acting hydraulic actuator. Hydraulic actuator 200 may have a stroke of up to about 18.3 m. Hydraulic actuator 200 may have a stroke of about 18.3 m. Hydraulic actuator 200 may have a stroke of less than about 18.3 m. Piston rod 208 may be oriented at least partially within cylinder barrel 202. Hydraulic actuator 200 may be configured to operate primarily in a mid-stroke position, such that about half the length of piston rod 208 extends outside cylinder barrel 202 and past gland 214 in average travel. Hydraulic actuator 200 may be configured to operate such mid-stroke plus or minus between about 2.0 m and about 3.0 m.

Hydraulic actuator 200 may operate with a response of about 3.0 m/s, such that piston rod 208 may extend or retract at a rate of about 3.0 m/s. Hydraulic actuator 200 may operate

with a response of greater than about 3.0 m/s. Hydraulic actuator 200 may operative with a response of less than about 3.0 m/s. Hydraulic actuator 200 may operate with a response of up to about 4.0 m/s. Hydraulic actuator 200 may operate with a response of greater than about 4.0 m/s. Hydraulic actuator 200 may operative with a response of less than about 4.0 m/s.

Piston rod 208 may deflect laterally up to about 30.5 cm at ⅓ extension (that is, with ⅓ the total length of piston rod 208 extended). Piston rod 208 may deflect laterally up to about 45.8 cm at ½ extension. Lateral deflection is deflection in the lateral direction of piston rod 208. The lateral direction of piston rod 208 is defined as that direction which is orthogonal to the axial direction of piston rod 208. The lateral direction of piston rod 208 is that direction that is parallel to its radius. The axial direction of piston rod 208 is that direction that is parallel to its length.

Distal rod end 204 may be configured to connect hydraulic actuator 200 to a riser. Distal rod end 204 may be configured to connect hydraulic actuator 200 to a tensioning ring. Proximal rod end 206 may be configured to connect hydraulic actuator 200 to an offshore oil platform or oil drillship. Distal rod end 204 may include an eye via which it may be connected to an object. Proximal rod end 206 may include an eye via which it may be connected to an object.

Gland 214 may encircle piston rod 208. Gland 214 may allow piston rod 208 to extend and retract from cylinder barrel 202 while preventing the escape of hydraulic oil from cylinder barrel 202. Gland 214 may contain at least one seal (not shown) at least substantially encircling piston rod 208. Gland 214 may contain at least one bearing device (not shown) at least substantially encircling piston rod 208.

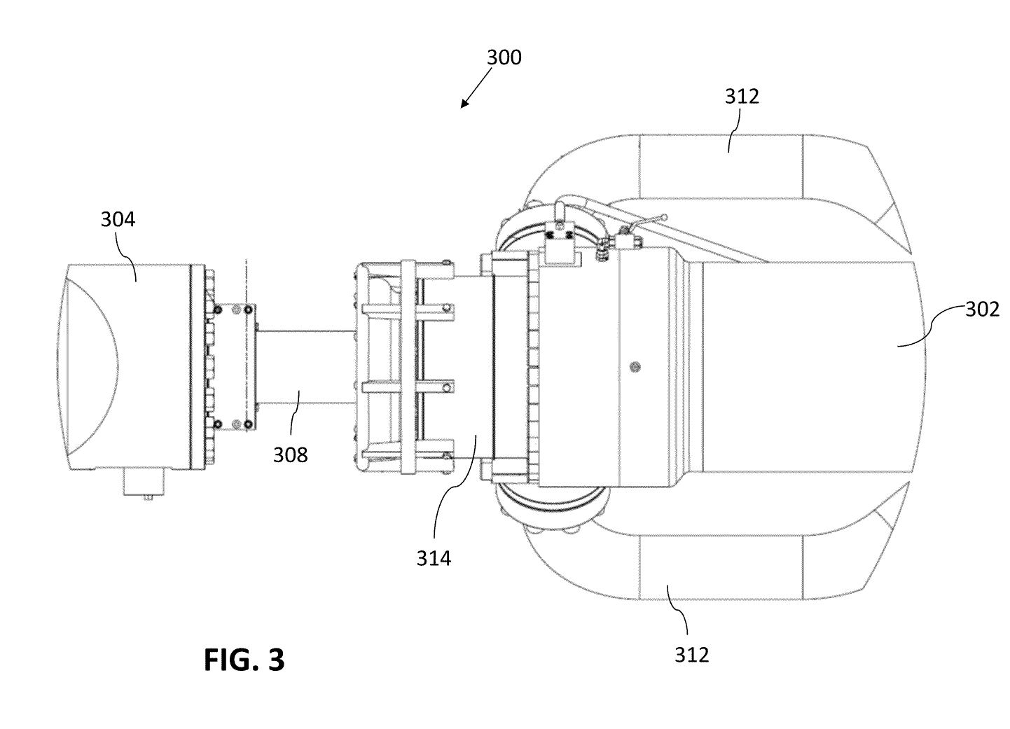

FIG. 3 illustrates a partial view of a hydraulic actuator 300. Hydraulic actuator 300 may include a cylinder barrel 302, a distal rod end 304, a piston rod 308, at least one inlet/outlet flow pipe 312, and a gland 314.

Gland 314 may be configured to cap the piston rod chamber of cylinder barrel 302. Gland 314 may be oriented such that piston rod 308 may translate through gland 314 during extension and retraction. Gland 314 may be oriented such that hydraulic oil contained within the piston rod chamber is retained in the piston rod chamber, both when piston rod 308 is at rest, as well as when piston rod 308 is in translation.

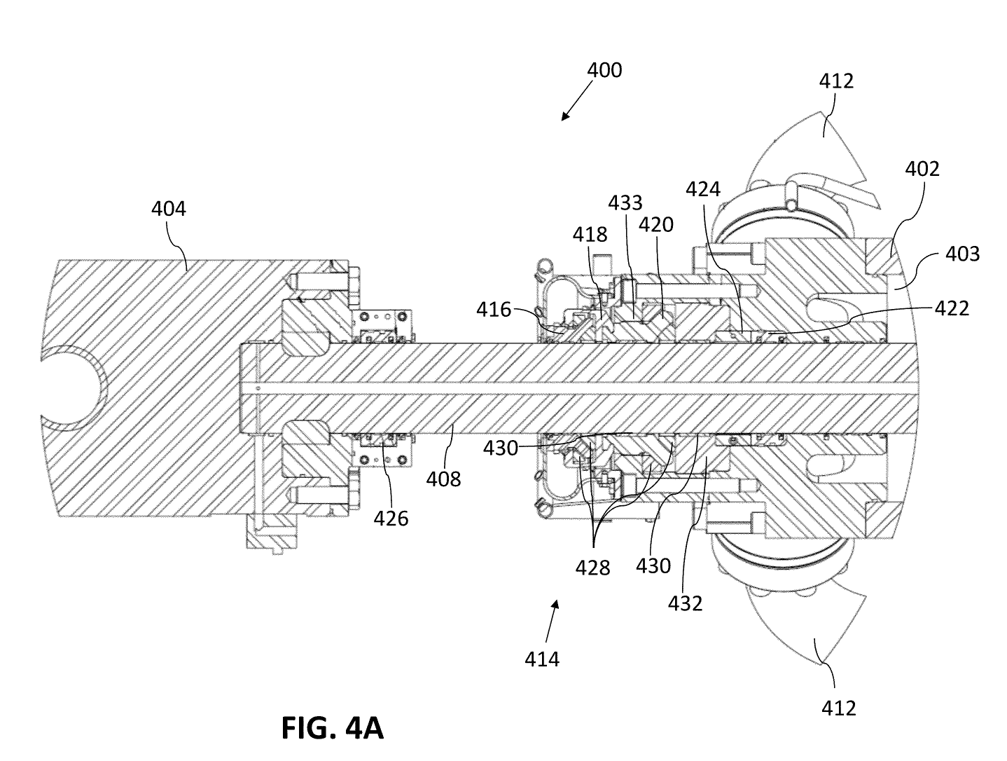

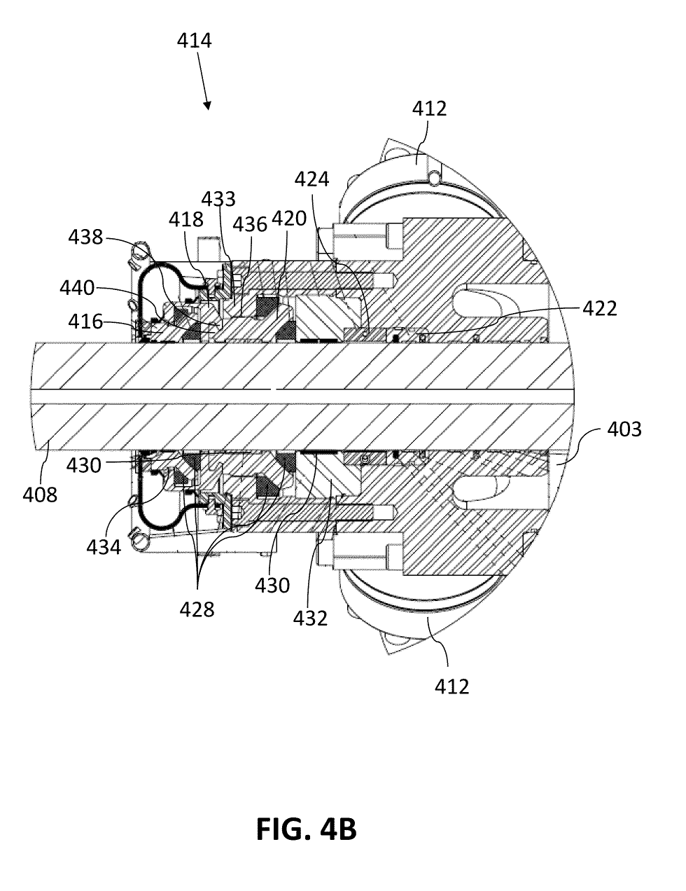

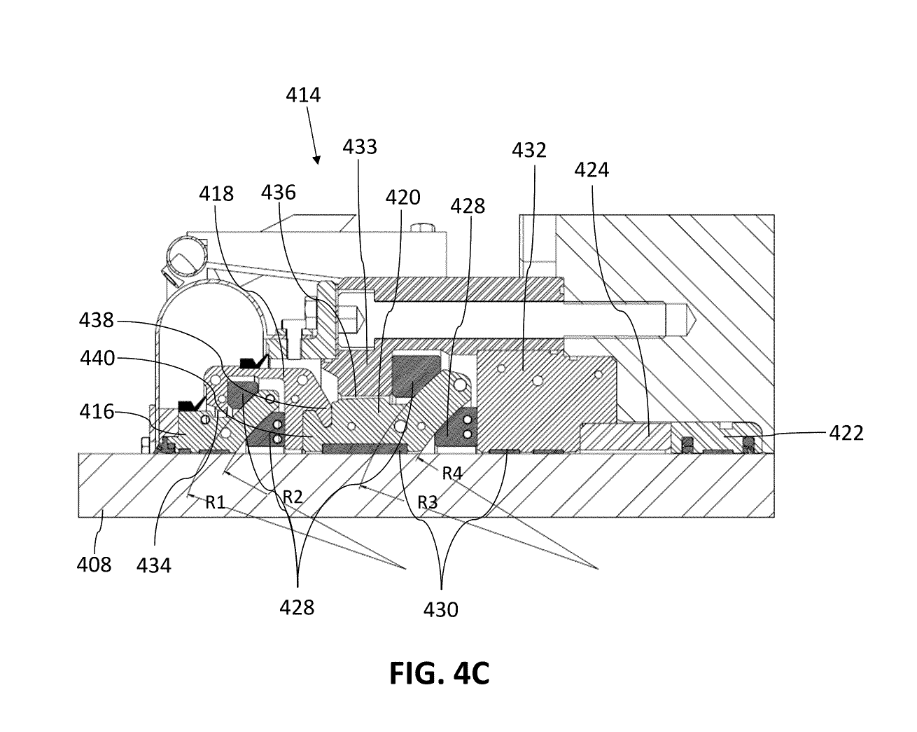

FIG. 4A illustrates a partial, sectional view of a hydraulic actuator 400. Hydraulic actuator 400 may include a cylinder barrel 402, a distal rod end 404, a piston rod 408, at least one inlet/outlet flow pipe 412, and a gland 414.

Gland 414 may include at least one bearing carrier. Gland 414 may include an outer bearing carrier 416. Gland 414 may include an intermediate bearing carrier 418. Gland 414 may include an inner bearing carrier 420. Gland 414 may include at least one packing canister 422. Gland 414 may include at least one packing canister spacer 424. Distal rod end 404 may include a spare packing canister 426. Gland 414 may include at least one bearing carrier wear bearing 428. Gland 414 may include at least one piston rod wear bearing 430. Gland 414 may include at least one extension carrier 432. Gland 414 may include at least one bearing holder 433.

Outer bearing carrier 416, intermediate bearing carrier 418, and inner bearing carrier 420 may comprise any of a variety of materials, including for example: a metal, a steel, an alloy, a composite, a polymer, and the like.

Outer bearing carrier 416 may be oriented axially closer to the distal end of hydraulic actuator 400. Outer bearing carrier 416 may comprise at least one element at least partially encircling piston rod 408. Outer bearing carrier 416 may comprise at least two sections, each extending partially about piston rod 408, and configured to be connected to one another to completely encircle piston rod 408. Outer bearing carrier 416 may comprise at least two sections, each extending partially about piston rod 408, and configured to be connected to one another so as to ease installation of outer bearing carrier 416 about piston rod 408 within gland 414. Outer bearing carrier 416 may comprise two sections, each extending about 180 degrees about piston rod 408, and configured to be connected to one another so as to ease installation of outer bearing carrier 416 about piston rod 408 within gland 414. Outer bearing carrier 416 may be configured to engage piston rod 408. Outer bearing carrier 416 may include a slide ring (not shown) oriented radially between outer bearing carrier 416 and piston rod 408, wherein the slide ring is configured to directly engage piston rod 408, and directly engage outer bearing carrier 416.

Outer bearing carrier 416 may be configured to laterally displace with piston rod 408 and relative to gland 414. Outer bearing carrier 416 may be configured to laterally displace with piston rod 408 so as to maintain engagement with piston rod 408 without damage to either piston rod 408 or outer bearing carrier 416. Outer bearing carrier 416 may be configured to angularly displace with piston rod 408 and relative to gland 414. Outer bearing carrier 416 may be configured to angularly displace with piston rod 408 so as to maintain engagement with piston rod 408 without damage to either piston rod 408 or outer bearing carrier 416.

At least a portion of intermediate bearing carrier 418 may be oriented axially between outer bearing carrier 416 and inner bearing carrier 420. Intermediate bearing carrier 418 may comprise at least one element at least partially encircling piston rod 408. Intermediate bearing carrier 418 may comprise at least two sections, each extending partially about piston rod 408, and configured to be connected to one another to completely encircle piston rod 408. Intermediate bearing carrier 418 may comprise at least two sections, each extending partially about piston rod 408, and configured to be connected to one another so as to ease installation of intermediate bearing carrier 418 about piston rod 408 within gland 414. Intermediate bearing carrier 418 may comprise two sections, each extending about 180 degrees about piston rod 408, and configured to be connected to one another so as to ease installation of intermediate bearing carrier 418 about piston rod 408 within gland 414. Intermediate bearing carrier 418 may be configured to engage piston rod 408.

At least a portion of intermediate bearing carrier 418 may be oriented radially outwardly of at least a portion of outer bearing carrier 416. At least a portion of intermediate bearing carrier 418 may be oriented radially outwardly of, and axially adjacent to, at least a proximal portion of outer bearing carrier 416. At least two portions of intermediate bearing carrier 418 may be oriented axially adjacent to, and on either side of (proximally and distally) at least a proximal portion of outer bearing carrier 416.

Intermediate bearing carrier 418 may be configured to laterally displace with piston rod 408 and relative to gland 414. Intermediate bearing carrier 418 may be configured to laterally displace with piston rod 408 so as to maintain engagement with piston rod 408 without damage to either piston rod 408 or intermediate bearing carrier 418. Intermediate bearing carrier 418 may be configured to angularly displace with piston rod 408 and relative to gland 414. Intermediate bearing carrier 418 may be configured to angularly displace with piston rod 408 so as to maintain engagement with piston rod 408 without damage to either piston rod 408 or intermediate bearing carrier 418.

Inner bearing carrier 420 may be oriented axially closer to the proximal end of hydraulic actuator 400 Inner bearing carrier 420 may comprise at least one element at least partially encircling piston rod 408 Inner bearing carrier 420 may comprise at least two sections, each extending partially about piston rod 408, and configured to be connected to one another to completely encircle piston rod 408. Inner bearing carrier 420 may comprise at least two sections, each extending partially about piston rod 408, and configured to be connected to one another so as to ease installation of inner bearing carrier 420 about piston rod 408 within gland 414. Inner bearing carrier 420 may comprise two sections, each extending about 180 degrees about piston rod 408, and configured to be connected to one another so as to ease installation of inner bearing carrier 420 about piston rod 408 within gland 414 Inner bearing carrier 420 may be configured to engage piston rod 408. Inner bearing carrier 420 may include wear bearing 430 oriented radially between inner bearing carrier 420 and piston rod 408, wherein wear bearing 430 is configured to directly engage piston rod 408 and directly engage inner bearing carrier 420.

Inner bearing carrier 420 may be configured to laterally displace with piston rod 408 and relative to gland 414 Inner bearing carrier 420 may be configured to laterally displace with piston rod 408 so as to maintain engagement with piston rod 408 without damage to either piston rod 408 or inner bearing carrier 420 Inner bearing carrier 420 may be configured to angularly displace with piston rod 408 and relative to gland 414. Inner bearing carrier 420 may be configured to angularly displace with piston rod 408 so as to maintain engagement with piston rod 408 without damage to either piston rod 408 or inner bearing carrier 420.

Inner bearing carrier 420 may include an inner bearing carrier engagement portion. Intermediate bearing carrier 420 may include an intermediate bearing carrier engagement portion. The inner bearing carrier engagement portion may be oriented radially inwardly of, and axially overlapping with, the intermediate bearing carrier engagement portion. The inner bearing carrier engagement portion may be oriented radially outwardly of, and axially overlapping with, the intermediate bearing carrier engagement portion.

At least one bearing carrier wear bearing 428 may be configured to substantially encircle piston rod 408. Bearing carrier wear bearing 428 may comprise any of a variety of materials configured to wear, prevent wear in piston rod 408, and prevent damage to piston rod 408, including for example: a polymer, a rubber, a composite, an alloy, a metal, and the like.

At least one bearing carrier wear bearing 428 may be oriented between outer bearing carrier 416 and intermediate bearing carrier 418. The at least one bearing carrier wear bearing 428 may be substantially annular in shape. The at least one bearing carrier wear bearing 428 may comprise independent portions, each of which extend at least partially circumferentially about an annulus (that is, each forms a portion of a ring, for example, 45, 90, or 180 degrees of a ring), and when each is combined form an annular shape. In one embodiment, outer bearing carrier 416 includes a proximal angled portion configured to fit within a socket in intermediate bearing carrier 418. At least one bearing carrier wear bearing 428 may be oriented between the proximal angled portion of outer bearing carrier 416 and intermediate bearing carrier 418. At least one bearing carrier wear bearing 428 may be oriented between the proximal angled portion of outer bearing carrier 416 and piston rod 408.

In one embodiment, inner bearing carrier 420 includes a proximal angled portion. At least one bearing carrier wear bearing 428 may be oriented between the proximal angled portion of inner bearing carrier 420 and bearing holder 433. At least one bearing carrier wear bearing 428 may be oriented between the proximal angled portion of inner bearing carrier 420 and piston rod 408. At least one bearing carrier wear bearing 428 may be oriented between the proximal angled portion of inner bearing carrier 420 and at least one extension carrier 432.

At least one piston rod wear bearing 430 may be configured to substantially encircle piston rod 408. The at least one piston rod wear bearing 430 may be substantially annular in shape. The at least one piston rod wear bearing 430 may comprise independent portions, each of which extend at least partially circumferentially about an annulus (that is, each forms a portion of a ring, for example, 45, 90, or 180 degrees of a ring), and when each is combined form an annular shape.

Piston rod wear bearing 430 may comprise any of a variety of materials configured to wear, prevent wear in piston rod 408, and prevent damage to piston rod 408, including for example: a polymer, a rubber, a composite, an alloy, a metal, and the like.

Inner bearing carrier 420 may include at least one piston rod wear bearing 430. At least one piston rod wear bearing 430 may be oriented between inner bearing carrier 420 and piston rod 408. Extension carrier 432 may include at least one piston rod wear bearing 430. At least one piston rod wear bearing 430 may be oriented between extension carrier 432 and piston rod 408.

At least one packing canister 422 may at least substantially encircle piston rod 408. At least one packing canister 422 may include at least two sections, each of which extends at least partially about piston rod 408, and each of which can be connected to one another. At least one packing canister 422 may completely encircle piston rod 408. At least one packing canister 422 may include at least two sections configured to be connected to one another to completely encircle piston rod 408. At least one packing canister 422 may include two sections, each of which extends about 180 degrees about piston rod 408, and each of which can be connected to one another.

At least one packing canister 422 may comprise at least one sealing device. At least one packing canister 422 may comprise any of a variety of sealing devices, including for example O-rings, gaskets, and the like. At least one packing canister 422 may be configured to at least substantially prevent the passage of a hydraulic oil from the piston rod chamber 403 and into gland 414.

At least one packing canister 422 may be oriented adjacent to packing canister spacer 424. Packing canister spacer 424 may be substantially the same size (that is, includes the same dimensions) as packing canister 422. Packing canister spacer 424 may be configured to at least partially encircle piston rod 408. Packing canister spacer 424 may include at least two sections, each of which extends at least partially about piston rod 408, and each of which can be connected to one another. Packing canister spacer 424 may completely encircle piston rod 408. Packing canister spacer 424 may include at least two sections configured to be connected to one another to completely encircle piston rod 408. Packing canister spacer 424 may include two sections, each of which extends about 180 degrees about piston rod 408, and each of which can be connected to one another.

In one embodiment, packing canister 422 may become damaged, worn, or otherwise incapable of sufficiently preventing the passage of hydraulic oil from piston rod chamber 403 and into gland 414. For example, at least one sealing device within packing canister 422 may become damaged and permit passage of hydraulic oil from piston rod chamber 403 into gland 414. In such an instance, packing canister spacer 424 may be removed and replaced with spare packing canister 426. Spare packing canister 426 may be substantially identical to packing canister 422, and may likewise comprise sealing devices configured to at least substantially prevent the passage of a hydraulic oil from piston rod chamber 403 and into gland 414.

Where piston rod 408 becomes damaged, for example via scratches, dents, gouges, or the like, piston rod 408 may abrade or otherwise damage the sealing devices within packing canister 422. As a result, a damaged packing canister 422 may become incapable of sufficiently preventing the passage of hydraulic oil. Hydraulic oil may thus leak from hydraulic actuator 400, the detrimental effects of which have been discussed above.

FIG. 4B illustrates a partial, sectional view of gland 414.

Gland 414 may include outer bearing carrier 416 and intermediate bearing carrier 418. Gland 414 may include an outer bearing carrier void 434 oriented between outer bearing carrier 416 and intermediate bearing carrier 418. Outer bearing carrier void 434 may comprise a machined tolerance to allow lateral and/or angular displacement of outer bearing carrier 416 relative to intermediate bearing carrier 418. Outer bearing carrier void 434 may be configured to allow outer bearing carrier 416 to remain in uniform, non-damaging contact with piston rod 408 during lateral displacement and/or bending of piston rod 408. Outer bearing carrier void 434 may include dimensions capable of allowing outer bearing carrier 416 to displace at least partially with piston rod 408 rather than causing damage to piston rod 408, as may a rigid and non-displaceable outer bearing carrier.

Outer bearing carrier 416 may include a substantially curvilinear member extending radially outwardly and/or axially proximally, which curvilinear member may be oriented between two bearing carrier wear bearings 428.

Gland 414 may include inner bearing carrier 420 and bearing holder 433. Gland 414 may include an inner bearing carrier void 436 oriented between inner bearing carrier 420 and bearing holder 433. Inner bearing carrier void 436 may comprise a machined tolerance to allow lateral and/or angular displacement of inner bearing carrier 420 relative to bearing holder 433. Inner bearing carrier void 436 may be configured to allow inner bearing carrier 420 to remain in uniform, non-damaging contact with piston rod 408 during lateral displacement and/or bending of piston rod 408 Inner bearing carrier void 436 may include dimensions capable of allowing inner bearing carrier 420 to displace at least partially with piston rod 408 rather than causing damage to piston rod 408, as may a rigid and non-displaceable outer bearing carrier.

The tolerance of outer bearing carrier void 434 may be about plus or minus 0.051 mm. The tolerance of outer bearing carrier void 434 may be about plus or minus 0.127 mm. The tolerance of outer bearing carrier void 434 may be between about plus or minus 0.051 mm and about plus or minus 0.127 mm. The tolerance of outer bearing carrier void 434 may be less than about plus or minus 0.051 mm. The tolerance of outer bearing carrier void 434 may be greater than about plus or minus 0.051 mm. The tolerance of outer bearing carrier void 434 may be less than about plus or minus 0.127 mm. The tolerance of outer bearing carrier void 434 may be greater than about plus or minus 0.127 mm.

In one embodiment, tolerances of outer bearing carrier void 434 greater than about plus or minus 0.051 mm may cause binding between carrier 416 and intermediate bearing carrier 418. In one embodiment, tolerances of outer bearing carrier void 434 less than about plus or minus 0.127 mm may cause binding between carrier 416 and intermediate bearing carrier 418.

The tolerance of inner bearing carrier void 436 may be about plus or minus 0.051 mm. The tolerance of inner bearing carrier void 436 may be about plus or minus 0.127 mm. The tolerance of inner bearing carrier void 436 may be between about plus or minus 0.051 mm and about plus or minus 0.127 mm. The tolerance of inner bearing carrier void 436 may be less than about plus or minus 0.051 mm. The tolerance of inner bearing carrier void 436 may be greater than about plus or minus 0.051 mm. The tolerance of inner bearing carrier void 436 may be less than about plus or minus 0.127 mm. The tolerance of inner bearing carrier void 436 may be greater than about plus or minus 0.127 mm.

In one embodiment, tolerances of inner bearing carrier void 436 greater than about plus or minus 0.051 mm may cause binding between inner bearing carrier 420 and bearing holder 433. In one embodiment, tolerances of inner bearing carrier void 436 less than about plus or minus 0.127 mm may cause binding between inner bearing carrier 420 and bearing holder 433.

Intermediate bearing carrier 418 may comprise an intermediate bearing carrier engagement portion 438. Intermediate bearing carrier engagement portion 438 may include a substantially hooked member, extending from a radially outward position and terminating in a radially inward direction. Intermediate bearing carrier engagement portion 438 may extend from a distal position and terminate in a proximal direction. Intermediate bearing carrier engagement portion 438 may include a rib extending radially inwardly from annular intermediate bearing carrier 418, and defining a groove extending radially outwardly within intermediate bearing carrier 418.

Inner bearing carrier 420 may comprise an inner bearing carrier engagement portion 440. Inner bearing carrier engagement portion 440 may include a substantially hooked member, extending from a radially inward position and terminating in a radially outward direction. Inner bearing carrier engagement portion 440 may extend from a proximal position and terminate in a distal direction. Inner bearing carrier engagement portion 440 may include a rib extending radially outwardly from an annular inner bearing carrier 420, and defining a groove extending radially inwardly within inner bearing carrier 420.

Intermediate bearing carrier engagement portion 438 may be configured substantially oppositely relative to inner bearing carrier engagement portion 440. Intermediate bearing carrier engagement portion 438 may be configured to substantially engage inner bearing carrier engagement portion 440. Intermediate bearing carrier engagement portion 438 may be configured to substantially engage inner bearing carrier engagement portion 440, such that lateral, axial, and/or angular displacement of one of intermediate bearing carrier 418 and inner bearing carrier 420 may cause like displacement of the other. In effect, intermediate bearing carrier engagement portion 438 and inner bearing carrier engagement portion 440 may engage one another to tie intermediate bearing carrier 418 to inner bearing carrier 420 Inner bearing carrier engagement portion 440 may engage a groove extending radially outwardly within intermediate bearing carrier 418. Intermediate bearing carrier engagement portion 438 may engage a groove extending radially inwardly within inner bearing carrier 420.

FIG. 4C illustrates a partial, sectional view of gland 414.

Outer bearing carrier 416 may include a proximal angled portion having a distal radiused edge having a radius R1 and a proximal radiused edge having a radius R2. Radius R1 may be about 190 mm. Radius R2 may be about 170 mm. The ratio of radius R1 to radius R2 may be about 1.12:1.

Inner bearing carrier 420 may include a proximal angled portion having a distal radiused edge having a radius R3 and a proximal radiused edge having a radius R4. Radius R3 may be about 208 mm. Radius R4 may be about 175 mm. The ratio of radius R3 to radius R4 may be about 1.19:1.

The bearing carrier system, comprising at least two of outer bearing carrier 416, intermediate bearing carrier 418, and inner bearing carrier 420, may be configured to displace at least one of laterally, axially, and angularly with piston rod 408. Such displacement may maintain uniform contact with piston rod 408. Such displacement may prevent generation of excessive force between the bearing carrier system and piston rod 408. The bearing carrier system may include bearing carriers in addition to outer bearing carrier 416, intermediate bearing carrier 418, and inner bearing carrier 420. The bearing carrier system may include less than the three bearing carriers included herein. It is contemplated that the bearing carrier system may include a plurality of bearing carriers. It is contemplated that the bearing carrier system may include two or more bearing carriers.

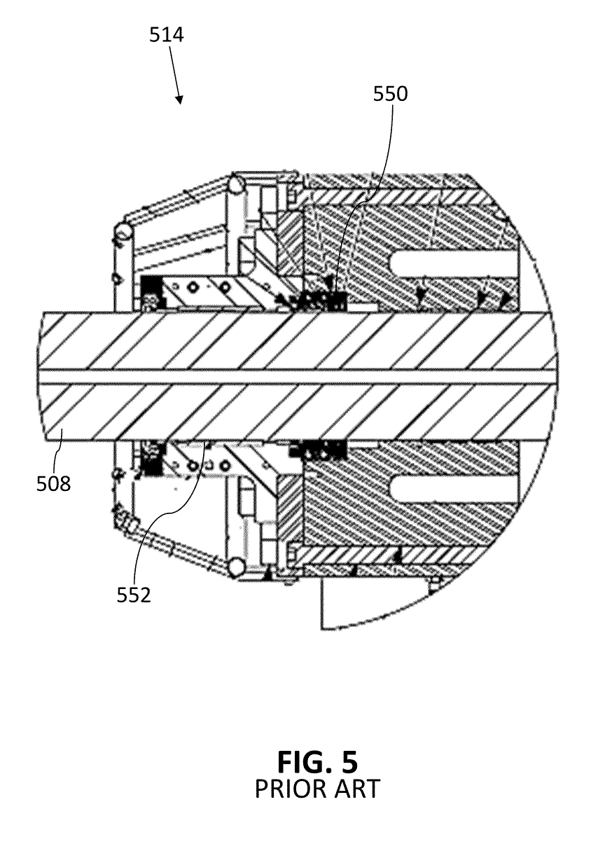

FIG. 5 illustrates a partial, sectional view of a prior art gland 514. Prior art gland 514 may include a piston rod 508 encircled by a packing canister 550 and at least one piston rod wear bearing 552. As illustrated, prior art gland 514 lacks any bearing carrier system configured to displace either laterally, axially, or angularly with piston rod 508. Rather piston rod wear bearing 552 is configured to be rigid and maintain its position regardless of lateral or angular displacement of piston rod 508.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A hydraulic actuator, comprising:
a proximal end;
a distal end;
a cylinder barrel;
a piston rod oriented at least partially within the cylinder barrel; and
a gland oriented near the distal end, the gland including an outer bearing carrier, an intermediate bearing carrier, and an inner bearing carrier,
wherein the outer bearing carrier is oriented axially closer to the distal end;
wherein the inner bearing carrier is oriented axially closer to the proximal end; and
wherein at least a portion of the intermediate bearing carrier is oriented axially between the outer bearing carrier and the inner bearing carrier.

2. The hydraulic actuator of claim 1, wherein the outer bearing carrier includes a proximal angled portion.

3. The hydraulic actuator of claim 2, wherein the intermediate bearing carrier includes a socket, and wherein the proximal angled portion of the outer bearing carrier extends at least partially into the socket.

4. The hydraulic actuator of claim 1, wherein the inner bearing carrier includes a proximal angled portion.

5. The hydraulic actuator of claim 1, wherein the gland further comprises at least one bearing carrier wear bearing oriented between the outer bearing carrier and the intermediate bearing carrier.

6. The hydraulic actuator of claim 1, wherein the gland further comprises at least one bearing holder, and wherein the gland further comprises at least one bearing carrier wear bearing oriented between the inner bearing carrier and the at least one bearing holder.

7. The hydraulic actuator of claim 1, wherein the inner bearing carrier includes at least one piston rod wear bearing oriented between the inner bearing carrier and the piston rod.

8. The hydraulic actuator of claim 1, wherein the gland further comprises at least one packing canister substantially encircling the piston rod, wherein the at least one packing canister includes at least one sealing device.

9. The hydraulic actuator of claim 1, wherein the intermediate bearing carrier includes an intermediate bearing carrier engagement portion, and wherein the inner bearing carrier includes an inner bearing carrier engagement portion, and wherein the intermediate bearing carrier engagement portion and the inner bearing carrier engagement portion substantially engage one another.

10. A hydraulic actuator gland, comprising:
an outer bearing carrier;
an intermediate bearing carrier; and
an inner bearing carrier;
wherein the outer bearing carrier is oriented axially closer to a distal end of the gland;
wherein the inner bearing carrier is oriented axially closer to a proximal end of the gland; and
wherein at least a portion of the intermediate bearing carrier is oriented axially between the outer bearing carrier and the inner bearing carrier.

11. The hydraulic actuator gland of claim 10, wherein the outer bearing carrier includes a proximal angled portion.

12. The hydraulic actuator gland of claim 11, wherein the intermediate bearing carrier includes a socket, and wherein the proximal angled portion of the outer bearing carrier extends at least partially into the socket.

13. The hydraulic actuator gland of claim 10, wherein the inner bearing carrier includes a proximal angled portion.

14. The hydraulic actuator gland of claim 10, further comprising at least one bearing carrier wear bearing oriented between the outer bearing carrier and the intermediate bearing carrier.

15. The hydraulic actuator gland of claim 10, further comprising at least one bearing holder, and further comprising at least one bearing carrier wear bearing oriented between the inner bearing carrier and the at least one bearing holder.

16. The hydraulic actuator gland of claim 10, wherein the inner bearing carrier includes at least one piston rod wear bearing oriented on a radially inward face of the inner bearing carrier.

17. The hydraulic actuator gland of claim 10, further comprising at least one packing canister, wherein the at least one packing canister includes at least one sealing device.

18. The hydraulic actuator gland of claim 10, wherein the intermediate bearing carrier includes an intermediate bearing carrier engagement portion, and wherein the inner bearing carrier includes an inner bearing carrier engagement portion, and wherein the intermediate bearing carrier engagement portion and the inner bearing carrier engagement portion substantially engage one another.

19. A hydraulic actuator gland, comprising:
an outer bearing carrier;
an intermediate bearing carrier;
an inner bearing carrier;
at least one bearing carrier wear bearing oriented between the outer bearing carrier and the intermediate bearing carrier;
at least one bearing holder; and
at least one bearing carrier wear bearing oriented between the inner bearing carrier and the at least one bearing holder;
wherein the outer bearing carrier is oriented axially closer to a distal end of the gland;
wherein the inner bearing carrier is oriented axially closer to a proximal end of the gland; and
wherein at least a portion of the intermediate bearing carrier is oriented axially between the outer bearing carrier and the inner bearing carrier.

20. The hydraulic actuator gland of claim 19, wherein the intermediate bearing carrier includes an intermediate bearing carrier engagement portion, and wherein the inner bearing carrier includes an inner bearing carrier engagement portion, and wherein the intermediate bearing carrier engagement portion and the inner bearing carrier engagement portion substantially engage one another.
